(19) United States
(12) Patent Application Publication
(10) Pub. No.: US 2024/0220145 A1
(43) Pub. Date: Jul. 4, 2024

(54) SYSTEMS AND METHODS OF REMOTE DATA STORAGE

(71) Applicant: Apple Inc., Cupertino, CA (US)

(72) Inventor: Srinivas VEDULA, Pleasanton, CA (US)

(21) Appl. No.: 18/397,902

(22) Filed: Dec. 27, 2023

Related U.S. Application Data
(60) Provisional application No. 63/477,810, filed on Dec. 29, 2022.

(51) Int. Cl. G06F 3/06

(52) U.S. Cl. CPC G06F 3/0646; G06F 3/0604; G06F 3/067

(57) ABSTRACT

A first device can be configured to transmit data to a second device for isolated storage in accordance with a determination that one or more criteria are satisfied. The data can be transmitted using a peer-to-peer network. A criterion of the one or more criteria can be satisfied when the second device is capable of separating the received data from other data stored at the second device. After transmitting the data, the first device can delete the data. The first device can retrieve the data in accordance with a determination that the first device is associated with the data.

### CROSS-REFERENCE TO RELATED APPLICATIONS

This application claims the benefit of U.S. Provisional Application No. 63/477,810, filed Dec. 29, 2022, the entire disclosure of which is herein incorporated by reference for all purposes.

### FIELD OF THE DISCLOSURE

This relates generally to storage of data and transferring data between devices.

### BACKGROUND OF THE DISCLOSURE

Electronic devices include memory components, such as volatile and non-volatile memories, configured to store data such as programs, files, etc.

### SUMMARY OF THE DISCLOSURE

Aspects of the present disclosure relate to systems and methods for remote data storage. For example, data can be communicated to and stored on the storage device. It is often advantageous to store the data on a second device for data redundancy (e.g., as a backup of the data on a first device), and/or to transfer data to the second devices to optimize use of on-device memory on the first device.

In some embodiments, a first device detects the presence of a second device. In some embodiments, the second device receives validation of, and indicates characteristics of the second device including its capability to store and isolate data received from the first device. In some embodiments, the first device validates the indicated characteristics of the second device and sends data from the first device to the second device. In some embodiments, the first device thereafter deletes the data from the first device. In some embodiments, the second device stores the received data in one or more portions of memory isolated from other data included in the second device. In some embodiments, the first device later requests retrieval of the data, and the second device sends the data from its isolated storage. In some embodiments, the second device thereafter deletes the data from the first device.

### BRIEF DESCRIPTION OF THE DRAWINGS

FIG. 1 illustrates an example of a plurality of devices configured for data storage in accordance with embodiments of the disclosure.

FIG. 2 illustrates an example flowchart of a plurality of devices communicating to store data in accordance with embodiments of the disclosure.

FIG. 3 illustrates a block diagram of a device configured for data storage in accordance with embodiments of the disclosure.

### DETAILED DESCRIPTION

In the following description of embodiments, reference is made to the accompanying drawings which form a part hereof, and in which it is shown by way of illustration specific embodiments that can be practiced. It is to be understood that other embodiments can be used and structural changes can be made without departing from the scope of the disclosed embodiments.

Aspects of the present disclosure relate to systems and methods for remote data storage. For example, data can be communicated to an edge node storage device and stored temporarily or permanently on the storage device. It is often advantageous to store the data on a second device for data redundancy (e.g., as a backup of the data on a first device), and/or to transfer data to the second device to optimize use of on-device memory on the first device. Such data can be transferred from the first device to the second device directly rather than through one or more intermediate devices (e.g., server(s)) to improve the speed and/or reliability of data transfer. The data transfer can be performed automatically and/or with a reduced need for express inputs to perform one or more data storage operations in accordance with the aspects of the present disclosure described herein.

In some embodiments, a first device detects the presence of a second device. The second device receives a request for validation of, and advertises characteristics of the second device including its capability to store and isolate data received from the first device. The first device validates the advertised characteristics of the second device and sends data from the first device to the second device. The first device thereafter deletes the data from the first device, for example, to free-up on-device memory for other applications. The second device stores the received data in one or more portions of memory, encrypted and optionally isolated from other data included in the second device. The first device may later request retrieval of the data, and the second device sends the data from its storage. In some embodiments, the second device thereafter deletes the data received from the first device.

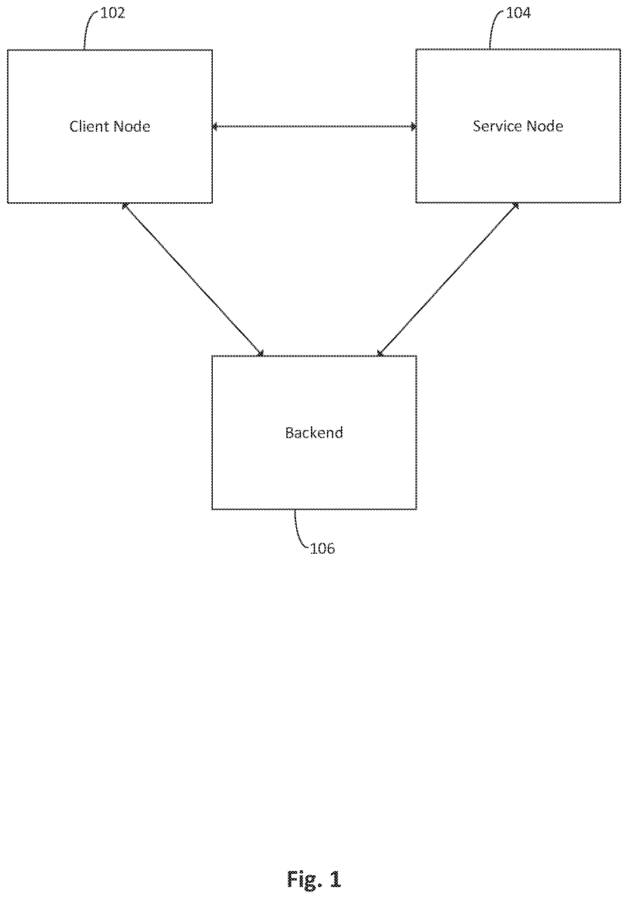

FIG. 1 illustrates an example of a plurality of devices configured for edge node storage in accordance with embodiments of the disclosure. For example, FIG. 1 illustrates a first electronic device (e.g., client node 102), a second electronic device (such as storage node 104), and a backend 106. In some embodiments, the backend is configured to validate information describing one or more characteristics of the first electronic device and/or describing one or more characteristics of the second electronic device. As indicated by the arrows between respective devices, information such as data and/or characteristics describing a respective device optionally is communicated between devices. It is noted that backend device 106 may perform a validation function indicating that client node 102 and storage node 104 may entrust one another, but the transfer of data from client node 102 occurs directly from node 102 to storage node 104, without the data being relayed through backend device 106.

In some embodiments, a first electronic device is configured to communicate with a second electronic device. The first electronic device such as client node 102 optionally is configured to detect a presence of the second electronic device such as storage node 104, query the second electronic device for information describing characteristics of the second electronic device, and when the characteristics meet one or more criteria, send data to the second electronic device. Examples of such characteristics of the second electronic device optionally include information describing capability of the second electronic to store the entirety of data the first electronic device would like to communicate, information describing capability of the second electronic device to isolate the data received from the storage device from other data stored at the second electronic device, and information describing capability of the second electronic device to limit access to the stored data from other electronic devices lacking sufficient privileges to such data. Such characteristics can also indicate a power and bandwidth capability of the second electronic device, such as whether the second electronic device is limited to battery power, and the bandwidth of its network connection. Configurations of such a first and second electronics devices provide proactive, intelligent, and secure data communication between electronic devices, improving security and efficiency of data communications over conventional approaches.

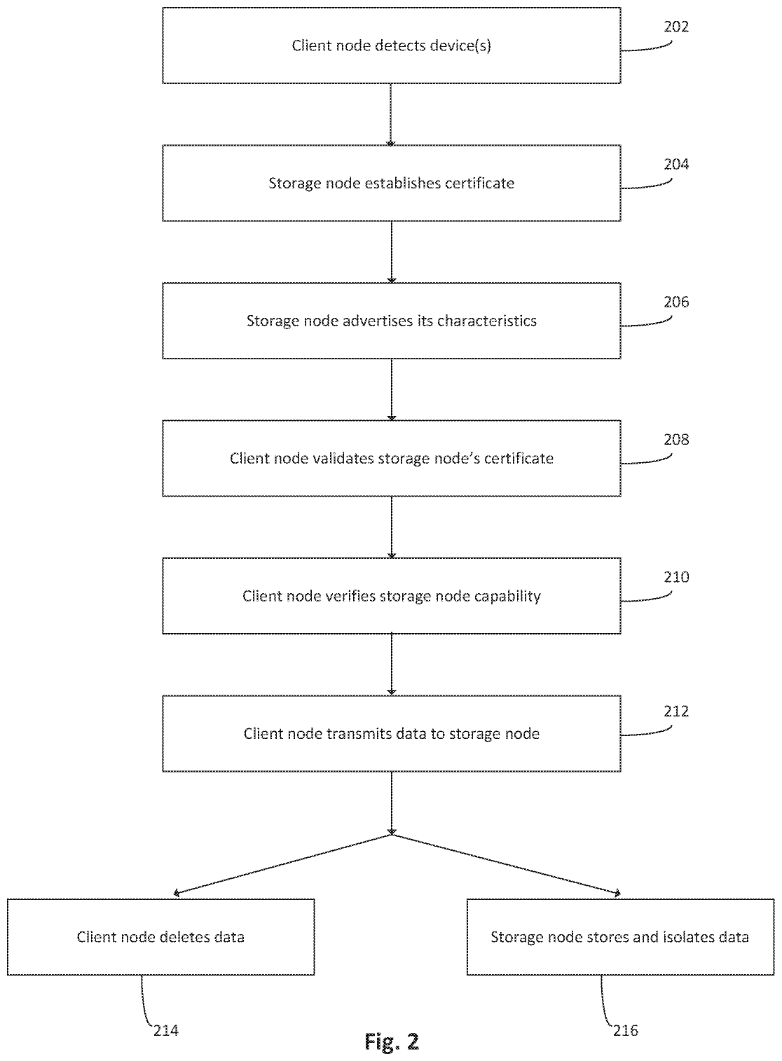

In some embodiments, the first electronic device is as a mobile phone, a tablet computer, a wearable device, and/or a laptop computer. The first electronic device includes memory configured to store data (e.g., media, software applications, cryptographic certificates, and/or configuration files). In some embodiments, the first electronic device is a portable device including one or more batteries configured to provide a power source to circuitry included in the first electronic device absent and/or in conjunction with a hardwired connection to a main power source from a power utility provider. The first electronic device—at times referred to herein as a “client node” corresponding to client node 102—optionally is configured to detect one or more other electronic device within its operating environment. In some embodiments, the one or more other electronic devices have one or more characteristics and/or are of a similar or the same type of electronic device as the first electronic device. In some embodiments, the second electronic device is a laptop computer or a desktop computer. Additionally or alternatively, the second electronic device—at times referred to herein as a “storage node,” such as storage node 104—optionally is not conveniently portable device, such as one or more computers configured as data servers. For example, the first electronic device optionally is a mobile phone and a second electronic device of the one or more other electronic devices optionally is a desktop computer or a server. As described previously, the first electronic device optionally is configured to detect one or more electronic devices that potentially are configured to store data from the first electronic device. In some embodiments, the first electronic device performs the detection periodically with a minimal amount of user input. For example, after receiving user input such as a toggling of a setting, a discovery mode of the first electronic device is enabled. While the discovery mode is enabled, the first electronic device periodically polls its environment for the presence of one or more other devices, described further with reference to FIG. 2.

While various techniques for access control and safeguards for user data are contemplated herein, implementers are reminded that user data should be handled in accordance with well-established privacy policies and practices, particularly those that are recognized as meeting or exceeding industry or governmental requirements for maintaining appropriate security. For instance, implementers should consider user interfaces on client nodes such as node 102 that inform its user as to whether or not to permit remote storage of data. For example, a user of node 102 can opt-in to cloud and/or edge storage. Similarly, implementers should consider user interfaces on storage nodes such as node 104 that inform its users, including administrators, on whether the device should be configured to act as an edge storage node. For example, operators of institutional services may opt-in while home or casual users may remain to opt-out of providing file storage services.

FIG. 2 illustrates an example flowchart of a plurality of devices communicating to store data in accordance with embodiments of the disclosure. In some embodiments, the first electronic device is configured to detect the presence of one or more other electronic devices. For example, at block 202 of FIG. 2, client node 102 optionally periodically polls for devices within its vicinity via a wireless communication protocol (e.g., Bluetooth, ZigBee, WiFi, cellular, mmWave, and/or 5GNR), and/or optionally polls for devices in response to and while connected to a wireless network (e.g., a WiFi network and/or a cellular network). As another example, client node 102 optionally receives an indication that a second electronic device (e.g., storage node 104) is available for a communication session. In some embodiments, the indication is a broadcast from the second electronic device. For example, in response to detecting the presence of and/or receiving indication(s) of the presence of storage node 104, client node 102 and/or storage node 104 optionally generate a secure communication channel to initiates secure communications of data, and communicates (e.g., sends) a request for information describing characteristics of storage node 104. In response to receiving the request for information, the storage node 104 optionally communicates information describing one or more of its characteristics to client node 102. In some embodiments, the indication that a second electronic device is available for a communication session includes some information, and the information describing one or more of the second electronic device's characteristics include additional or different information than the indication.

In some embodiments, the second electronic device communicates with a certificate authority to validate one or more packages of information describing characteristics of the second electronic device. At block 204 of FIG. 2, the second electronic device (e.g., a storage node) initiates a communication session with an entity responsible for validating information from a respective electronic device describing its characteristics. For example, the second electronic device optionally communicates information including, but not limited to, an identity (e.g., name, serial number, and/or device type), capability of the second electronic device to isolate received data from other data stored on the second electronic device as described further herein, software included at the second electronic device (e.g., operating system, firmware, software applications, and/or supported data transfer and/or storage protocols and/or schema), hardware included at the second electronic device (e.g., processor(s), memory type, an amount of memory, power source(s) such as batteries, and/or available communication circuitry and/or configurations of such communication circuitry), indication(s) of types of data storage available at the second electronic device, a maximum number of simultaneous possible connections with other electronic devices, and/or an amount of storage available for data received from another electronic device. In some embodiments, the validation of the information is performed during one or more communication sessions other than the communication session described previously. In some embodiments, the one or operations described with reference to FIG. 2 are performed independently of the validation operation (e.g., without performing one or more of the operations described with reference to block 204).

In some embodiments, information describing characteristics of an electronic device is verified with an entity responsible for validation, such as a certificate authority. For example, backend 106 optionally is an electronic device such as a server configured to receive the one or more packages of information describing characteristics of the second electronic device, such as one or more certificates describing the one or more characteristics of client node 102 and/or storage node 104. In response to receiving the certificate(s) and/or the information, the certificate authority optionally validates an identity of the respective electronic device (e.g., node) and/or characteristics of the respective electronic device that provided the certificate, and optionally signs the certificate to convey proof of the validation. For example, backend 106 optionally signs the one or more certificates and/or provides a date indicating a time and/or date that the identity of the device providing the certificate was verified and sends the signed one or more certificates back to node 104. In future communications (e.g., between client node 102 and storage node 104), a first electronic device having verified information describing its characteristics thereby can be trusted to a greater to degree than a second device lacking such verified information, thus improving a level of trust associated with the first electronic device relative to the second electronic device. It is understood that such verified information can be requested and obtained from a shared certificate authority (e.g., backend 106) by one or more devices, such as client node 102 and storage node 104, and that the amount of information provided to the shared certificate authority optionally is different for different classes of devices. For example, client node 102 optionally is configured to communicate data for storage at the node 104, and the level of information scrutinized and required by backend 106 for the storage node 104 is optionally greater than the amount of information scrutinized and required by node 102 because backend 106 requires a higher level of trust in potential storage devices (e.g., storage nodes).

In some embodiments, after receiving a signed certificate and/or another indication verifying the identity and/or characteristics of the second electronic device, the second electronic device optionally communicates its capability using the verified information describing its characteristics. In some embodiments, the second electronic device proactively communicates (e.g., advertises) its characteristics as shown in block 206 of FIG. 2, and the first electronic receives the information describing characteristics of the second electronic device without an express communication requesting the information. Regardless of how the information is solicited, in some embodiments, the first electronic device receives information describing characteristics including (but not limited to) capability of the second electronic device to isolate data received from a client node (e.g., the first electronic device) from other data stored on the second electronic device. It is noted that, more generally speaking the types of information communicated by the second electronics device regarding its data storage capabilities is in with accordance with configuration settings assigned to the device by its owner and/or administrator. For example, an administrator may configure or otherwise opt-in the second electronic device to become available as an edge storage node.

In some embodiments, the second electronic device is configured to isolate data from a client node, such as the first electronic device, from other data, so that a client node has an assurance that its data will be secure and will not comingle with data from other client nodes and/or with data stored at the second electronic device. For example, storage node 104 optionally configures one or more portions of memory included in storage node 104 to store one or more files communicated from client node 102 without storing any additional data received from a different electronic device within the one or more portions of memory designated for client node 102. In some embodiments, the second electronic device is capable of creating one or more temporary volumes and/or partitions associated with the first electronic device to store the data received from the first electronic device. Further description of the capability of the second electronic device to isolate data from the client node is described further with reference to “access privileges” herein.

In some embodiments, the second electronic device has additional or alternative characteristics other than its capability to isolate received data that are communicated to the first electronic device. For example, the second electronic device optionally indicates one or more data types it is capable of storing, such as one or more filetypes that can be stored on the second electronic device. As an example, the second electronic device optionally provides information indicating it is able to store spatial data collected by another (e.g., the first) electronic device of a physical room, media (e.g., photos and/or video) collected by another device, and/or one or more software packages. In some embodiments, the characteristics include an amount of remaining storage at the second electronic device and/or a format of one or more partitions, volumes, and/or the memory included in the second electronic device. In some embodiments, the characteristics indicate that the second electronic device is configured for data syncing between one or more other devices (e.g., one or more servers configured as cloud storage, and/or one or more storage nodes similar or the same as the second electronic device). In some embodiments, the second electronic device provides the one or more characteristics described herein without communicating indications of the content of the data, such as what data types are stored at the second electronic device, what the data itself comprises, and/or any other information that the first electronic device does not desire to share with other electronic devices (e.g., client nodes).

At block 208 of FIG. 2, the first electronic device optionally verifies the information describing characteristics of the second electronic device. For example, node 102 optionally initiates a separate communication session from previous communication sessions with backend 106, communicating a request that the information be verified and/or that a previous verification (e.g., the signing of a certificate) is still valid. In some embodiments, in accordance with a determination that the verification of the information continues to be valid (e.g., because the certificate was signed within a window of time of a request to verify the certificate), the first electronic device considers the information to be verified without communicating with a certificate authority for an additional step of verification (e.g., without performing one or more operations described with reference to block 208). In some embodiments, the verification optionally is performed at a secure processor (e.g., a secure enclave processor) of the first electronic device and/or the certificate authority. In some embodiments, the first electronic device prompts a user of the first electronic device (e.g., an individual interacting with a user interface displayed by the first electronic device and/or via a display in communication with the electronic device) to perform biometric authentication and/or enter a passcode to authorize the verification and/or to perform the verification, such as one or more scans of a face, hand, finger, fingerprint, and/or a head of the user. In accordance with a determination that the user authentication is successful, the first electronic device proceeds to verify the certificate of the second electronic device and to perform additional operations to perform data storage as described with reference FIG. 2. In accordance with a determination that the user authentication is unsuccessful (e.g., wrong passcode), the first electronic device forgoes one or more of the operations to perform the data storage. In some embodiments, the authorization is performed without prompting the user of the first electronic device and without one or more express inputs to perform the authorization. For example, if a user has previous selected the second electronic device as an approved storage location, the first electronic device can perform the verification in the background in accordance with the user configuration, so that the user need not be prompted for authentication credentials each time the first and second devices come within communications range. In some embodiments, the first electronic device requests the information describing characteristics of the second electronic device separately from the verification steps described above. For example, the first electronic device optionally communicates a request to the second electronic device for the verified information during a separate communication session, and in response, the second electronic device communicates the verified information.

At block 210 of FIG. 2, the first electronic device verifies that the second electronic device is capable of storing and/or isolating its data. For example, the first electronic device optionally determines that the information describing the one or more characteristics of the second electronic device satisfy one or more criteria, such as a criterion that is satisfied when the second electronic device is capable of isolating data from the first electronic device. Additionally or alternatively, the one or more criteria include a criterion that is satisfied when the second electronic device supports storage of the data type(s) of the data provided by the first electronic device, a criterion satisfied when the second electronic device has a sufficient amount of available storage to store the data provided by the first electronic device, a criterion satisfied when the first electronic device has previously communicated and/or verified an identity of the second electronic device, a criterion satisfied when the first electronic device and the second electronic device share a communication network (e.g., a peer-to-peer wireless network, such as a WiFi network or WiFi Direct), and/or another suitable criterion associated with the one or more characteristics of the second electronic device. In some embodiments, the one or more criteria are not satisfied, and the first electronic device forgoes communication of its data to the second electronic device. For example, the first electronic device optionally determines that the second electronic device does not support storage of data types included in the data that the first electronic device would like to communicate, the second electronic device does not have the sufficient amount of available storage to store the data and/or cannot create sufficient one or more portions in memory to store the received data, does not have a verified identity and/or the identity verification of the second electronic device is no longer valid (e.g., a certificate was verified at a time past a threshold amount of time), and/or the second electronic device does not share the communication network of the first electronic device; accordingly, the second electronic device optionally forgoes performance of one or more further operations to store the data.

At block 212 of FIG. 2, when the first electronic device verifies the second electronic device is capable of the storing and/or isolating its data, the first electronic device communicates its data to the second electronic device. For example, when the one or more criteria described previously are satisfied, the first electronic device determines that the second electronic device is capable of handling a request to store its data, and thereafter sends its data to the second electronic device. In some embodiments, the first electronic device maintains an indication that the second electronic device is verified and capable of the storage and/or isolation, but does not immediately communicate the data. For example, the first electronic device optionally displays a visual indication (e.g., text and/or a pictorial icon) that the second electronic device is capable of data storage, such as an identifier naming the second electronic device. In response to receiving user confirmation, such as by way of input selecting the visual indication representing the second electronic device (e.g., a contacting of a touch screen corresponding to the identifier of the second electronic device, a voice command, and/or a selection using a pointing device such as a computer mouse and/or a stylus), the first electronic device optionally initiates the one or more data storage operations described with reference to block 210. Additionally or alternatively, the first electronic device optionally prompts the user to perform the authentication (e.g., biometric authentication, passcode entry) described with reference to block 208 in response to the selection of the visual indication, and performs or forgoes the communication of the data based on the successfully or unsuccessful authentication of a user of the first electronic device, respectively. In some embodiments, the first electronic device communicates the data via a communication channel directly to the second electronic device (e.g., via a Bluetooth communication session, WiFi Direct, or another suitable communication protocol). In some embodiments, the data is communicated via a communication channel using a shared network (e.g., a wireless network such as a WiFi network). In some embodiments, in response to communicating data to the second electronic device (e.g., after confirmation of storage from the second electronic device), the first electronic device deletes the data from its memory, thus optimizing storage on the electronic device, as shown at block 214 of FIG. 2. In some embodiments, in response to receiving the data at the second electronic device, the second electronic device stores the received data within isolated one or more portions of memory of the second electronic device, as shown at block 216 of FIG. 2.

In some embodiments, data stored within temporary volumes and/or partitions designated for isolated storage are only accessible when a client node requesting access to the data has access privileges associated with the temporary volume(s) and/or partitions. For example, client node 102 (e.g., the first electronic device) optionally has previously communicated data that is stored data at storage node 104 (e.g., the second electronic device), and client node 102 optionally communicates a request for the stored data. In accordance with a determination that client node 102 originally provided the requested data, storage node 104 optionally communicates the requested data to client node 102. In some embodiments, the request for the stored data additionally causes node 104 to delete the stored data from memory (e.g., after the request has been successfully processed, the data has been successfully stored and isolated at the second electronic device, and/or an indication of the successful storage and/or isolation has been completed). As another example, in response to receiving a request for the data (e.g., received from client node 102) made by a third electronic device (e.g., another client node such as another mobile device, wearable device, and/or laptop computer other than client node 102), storage node 104 optionally forgoes communication of the data to the third electronic device, at least because the third electronic device did not provide the data to storage node 104. In some embodiments, the second electronic device grants access of data from the first electronic device to the third electronic device when the third electronic device has one or more characteristics indicating access privileges to the data. For example, when the third electronic device is associated with privileges granting access to data received from client node 102 (e.g., when storage node 104 is aware that client node 102 and the third electronic device are owned by a shared user), the second electronic device optionally communicates the data in response to receiving the request for the data. In some embodiments, the third electronic device has one or more characteristics of similar or the same as the first electronic device. For example, the first and the third electronic device optionally are both mobile phones that are associated with different respective user credentials. In some embodiments, the third electronic device has one or more characteristics that are unique to the third electronic device. For example, the first electronic device optionally is associated with a first user account having second credentials (e.g., passcode(s), biometric identifier(s), and/or cryptographic key(s), token(s), and/or certificate(s)) corresponding to the owner of the first account, and the third electronic device optionally is associated with a second, different user account associated with second credentials, optionally at least partially different from the first credentials.

In some embodiments, the access privileges are conferred to the third electronic device in accordance with a determination that the first electronic device has granted such privileges. For example, in response to receiving a request for data from the third electronic device that is sourced from the first electronic device, the second electronic device optionally communicates a request for approval of the request to the first electronic device. The first electronic device optionally displays a prompt to approve the access privileges to the third electronic device (e.g., prompting for selection of a user interface button, entry of biometric information such as a facial scan, and/or announces an audible prompt for approval) and in response to receiving an approval of the access privileges, communicates an indication of the approval to the second electronic device. In response to receiving the indication of approval, the second electronic device optionally grants access privileges to the third electronic device (e.g., temporarily or until the first electronic device revokes the access privileges), and communicates the requested data to the third electronic device.

In some embodiments, the third electronic device is granted access privileges to data from the first electronic device in accordance with a determination that one or more access criteria are satisfied. For example, the one or more access criteria optionally include a criterion that is satisfied when the third electronic device is in communication with a network (e.g., a wireless network such as WiFi) that is shared with the first electronic device and/or the second electronic device. For example, the first, second and/or third electronic device optionally are connected to a same WiFi network, local mesh network, and/or another wireless network. In some embodiments, the one or more access criteria include a criterion that is satisfied when the third electronic device is associated with a class of users (e.g., the first electronic device and the third electronic device are a part of a group owned by a family, and/or are part of a subgroup such as the children of the family). In some embodiments, the one or more access criteria include a criterion that is satisfied when the third electronic was previously granted access privileges within a threshold amount of time of a current request for data. For example, the third electronic device optionally was granted access during a first communication session with the second electronic device based on an express approval from the first electronic device, and at a later time (e.g., within 10 minutes, an hour, a day, and/or a week) of receiving the approval, initiates a second communication session with the second electronic device and is granted access to data stored at the second electronic device and received from the first electronic device.

In some embodiments, access privileges are granted to the third electronic device until the third electronic device leaves a shared communication network (e.g., a wireless network), terminates a communication session with the first and/or the second electronic devices, in accordance with a determination that one or more communication signals between the first and second device are insufficient in quality (e.g., received power, signal quality, and/or a bit-error ratio of the signals are insufficient) and/or moves outside a threshold distance of the first and/or the second electronic devices. In some embodiments, the access privileges are granted in accordance with a determination that the third electronic device is associated with a class of device of an approved class of devices. For example, the second electronic device optionally grants access to data received from mobile phones to other mobile phones having verified information describing respective characteristics of the mobile phones received from a certificate authority, such as backend 106.

In some embodiments, the second electronic device maintains storage of data received from the first electronic device until one or more deletion criteria are satisfied. The one or more deletion criteria optionally include a criterion that is satisfied when the data has been stored for a threshold amount of time (e.g., 1 hour, 12 hours, 24 hours, 1 week, 6 months, and/or 12 months). Additionally or alternatively, the one or more deletion criteria optionally include a criterion that is satisfied when the first electronic device sends an express request to delete the data from the second electronic device. In some embodiments, prior to deleting the data, the second electronic device stores the data in a third, trusted electronic device. For example, the third electronic device optionally corresponds to one or more cloud storage servers and the second electronic device optionally communicates the data from the first electronic device (e.g., to back up the data) prior to deleting the data based on satisfaction of the one or more deletion criteria. Accordingly, when the first electronic device later communicates a request for its data from the second electronic device that has deleted and communicated the data to the third electronic device, the second electronic device optionally communicates a request to retrieve the data from the third electronic device, receives the data from the third electronic device, and communicates the data back to the first electronic device. In some embodiments, in accordance with a determination that the one or more deletion criteria are not satisfied, the second electronic device maintains the data in storage. For example, the second electronic device optionally determines that the data has not yet been stored for an amount of time greater than the threshold amount of time, has not received the request to delete the data from the second electronic device, has not yet communicated the data to the third storage device, and/or the first electronic device has previously communicated an express request to preserve the data in memory at the second electronic device, and accordingly maintains the data in memory.

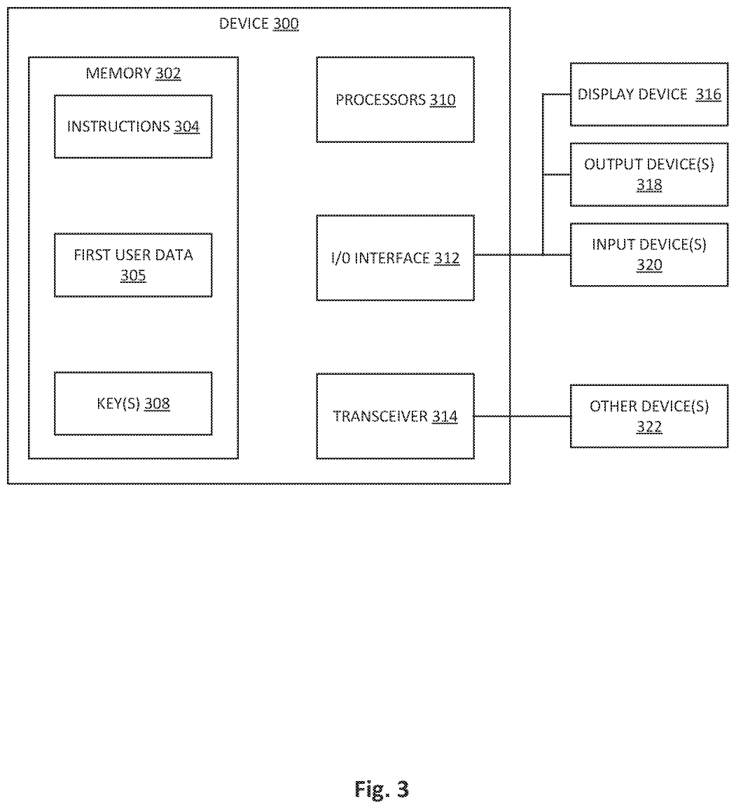

FIG. 3 is an example block diagram of an electronic device 300 according to some embodiments of the disclosure. In some embodiments, the electronic device 300 includes memory 302, one or more processors 310, an I/O interface 112, and a transceiver. In some embodiments, the electronic device 300 includes additional or alternative components.

In some embodiments, memory 302 of electronic device 300 includes volatile and/or non-volatile memory implemented using electronic, electromagnetic, magnetic, infrared, optical, and/or semiconductor system(s) and/or device(s). Examples of suitable memory circuitry include random access memory (RAM) devices (e.g., static random-access memory (SRAM), double-data-rate random-access memory (DDR RAM), dynamic random-access memory (DRAM), or other high-speed RAM or solid-state RAM, etc.), flash memory devices, read-only memory (ROM) devices, or erasable or electrically erasable programmable read-only memory devices (EPROM or EEPROM). Other types of memory are possible in some embodiments. In some examples, memory 302 can be separate from the one or more other components of electronic device 300 and electrically coupled to the one or more other components of electronic device 300 for read and/or write operations. In some examples, some of memory 302 can be integrated within other components of electronic device 300.

In some examples, at least a portion of the memory 302 can be referred as a computer-readable storage medium. Memory 302 and/or a transitory or non-transitory computer readable storage medium of memory 302 can store instructions, programs, data structures and/or modules or a subset or combination thereof in some embodiments. In some embodiments, memory 302 and/or the computer readable storage medium can store instructions, which when executed by processors 310, can cause the electronic device 300 (or a computing system more generally) to perform one or more functions and methods of one or more examples of this disclosure, such as one or more of the methods described herein with reference to FIGS. 1-2. As used herein, a “non-transitory computer-readable storage medium” includes any tangible medium (e.g., excluding signals) that can contain or store programs/instructions for use by the electronic device (e.g., processing circuitry), for example.

As shown in FIG. 3, additionally or alternatively, the memory 302 of electronic device 300 stores first data 305 and one or more keys 308. In some embodiments, the first data 305 includes user data associated with a first user account into which the electronic device 300 is signed in. For example, signing into the first user account enables a user to use the electronic device 300 to access files, programs, communication accounts (e.g., e-mail accounts or other messaging accounts), and/or other data private to the user account and enables the electronic device 300 to operate according to settings selected by a user and saved to the first user account. In some embodiments, the electronic device 300 stores the first data 305 using a file system. In some embodiments, the file system includes data structures for storing, retrieving, and/or identifying various data stored in memory 302 on the electronic device 300.

As described herein with reference to FIGS. 1-2, in some embodiments, the electronic device 300 receives a request to access data and stored in memory 302 from a second electronic device included in the other device(s) 322 in communication with electronic device 300. In some embodiments, the data is associated with another electronic device. In some embodiments, the temporary file system includes data structures for storing, retrieving, and/or identifying the data.

In some embodiments, the electronic device 300 further includes one or more processors 310. Processors 310 can include graphics processing units (GPUs), central processing units (CPUs), microprocessors, microcontrollers, programmable logic device (PLD), field-programmable gate arrays (FPGAs), application specific integrated circuits (ASICs), digital signal processors (DSPs), or any suitable processing circuitry. The electronic device 300 can use processors 310 to perform any of the functions, processes, and/or methods described herein (e.g., optionally by executing instructions or programs stored in memory 302 and/or a non-transitory computer-readable storage medium).

In some embodiments, the electronic device 300 further includes an I/O interface 312. I/O interface 312 includes circuitry such as data lines, address lines, and control lines, for example, that enable communication between the electronic device 300 and one or more peripherals, such as display device 316, output device(s) 318, and input device(s) 320. Example display devices include, but are not limited to, monitors, television screens, touch screens, projectors, and/or head mounted displays implemented with LCD (liquid crystal display), LED (light emitting diode), OLED (organic light emitting diode), and/or other technology. Examples of other output device(s) 318 include, but are not limited to audio output devices (e.g., wired and/or wireless speakers and/or headphones), tactile output devices (e.g., haptic and/or vibration devices), and other visual output devices (e.g., indicator lights). Example input device(s) 320 include camera(s) (e.g., visible light cameras and/or infrared cameras), depth sensors (e.g., range sensors and/or LiDAR), trackpads, mouses, touch screens, microphones, keyboards, pedals, remote controls, and/or video game controllers.

In some embodiments, the electronic device 300 includes a transceiver 314. Transceiver 314 includes transmitter and/or receiver circuitry, including but not limited to signal generator(s), oscillator(s), modulator(s), encoder(s), amplifier(s), antenna(s), demodulator(s), filter(s), decoder(s), and/or tuner(s), for example. In some embodiments, the transceiver 314 is configured to communicate with other device(s) 322 (e.g., including the second electronic device described above and below with reference to FIGS. 1-2) using one or more protocols, including but not limited to, Bluetooth, WiFi, radio, cellular communication, satellite communication, and/or wired communication.

As described above, the components and configuration of components of electronic device 300 according to the disclosure are not limited by the example illustrated and described with reference to FIG. 3. In some embodiments, one or more of the components of the electronic device 300 included in FIG. 3 and any additional components of the electronic device 300 not shown in FIG. 3 are in communication with each other and/or integrated with each other. For example, in embodiments where device 300 represents a smart phone, display device 316, output device(s) 318, and input device(s) 320 would be integrated with the other components of device 300. In some embodiments, additional or alternative components and/or configurations are possible.

Therefore, according to the above, some embodiments are directed to a method performed at an electronic device configured to communicate with a storage device separate from the electronic device comprising detecting the storage device, receiving, from the storage device, information about characteristics of the storage device, including one or more first characteristics describing capability of the storage device to isolate first data received from the electronic device from other data stored on the storage device. In accordance with a determination that the information about characteristics of the storage device satisfies one or more criteria, sending the first data to the storage device for isolated storage on the storage device; and in accordance with a determination that the information about characteristics of the storage device does not satisfy the one or more criteria, forgoing the sending of the first data to the storage device. Additionally or alternatively, in some embodiments the sending of the first data occurs during a first communication session, the method further comprising during a second communication, different from the first communication session, sending a request for the first data to the storage device and receiving the first data from the storage device. The receiving can be based on the request for the first data. Additionally or alternatively, in some embodiments the sending of the first data occurs during a first communication session, the method further comprising: during a second communication session, different from the first communication session in accordance with the determination that the information about characteristics of the storage device satisfies the one or more criteria, sending second data, different from the first data, to the storage device for isolated storage, and in accordance with the determination that the information about characteristics of the storage device does not satisfy the one or more criteria, forgoing the sending of the second data to the storage device. Additionally or alternatively, in some embodiments the method further comprises during a third communication session, different from the first communication session, sending a request for the first and the second data to the storage device and receiving the first and the second data from the storage device. The receiving can be based on the request for the first and the second data. Additionally or alternatively, in some embodiments the method further comprises sending a request for second data, different from the first data. The second data can be stored at the storage device. The method can further comprise receiving an indication that the second data is not accessible to the electronic device from the storage device. Additionally or alternatively, in some embodiments the information about characteristics of the storage device further comprises one or more second characteristics indicative of capability of the storage device to store the first data, and the one or more criteria include a first criterion that is satisfied when the one or more second characteristics indicate the storage device is capable of storing the first data. Additionally or alternatively, in some embodiments the information about characteristics of the storage device further comprises one or more second characteristics indicative of a level of trust associated with the storage device, and the one or more criteria include a first criterion that is satisfied when the one or more second characteristics include an indication of verification of an identity of the storage device. Additionally or alternatively, in some embodiments the electronic device is a portable device. Additionally or alternatively, in some embodiments the method further comprises after sending the first data, deleting the first data from the electronic device. Additionally or alternatively, in some embodiments the method further comprises after detecting the storage device, establishing a secure communication channel with the storage device. Additionally or alternatively, in some embodiments the method further after detecting the storage device, sending information about characteristics of the electronic device. Additionally or alternatively, in some embodiments the information about characteristics of the storage device includes a first set of characteristics, the information about characteristics of the electronic device includes a second set of characteristics, and the first set of characteristics includes a different amount of respective characteristics than the second set of characteristics. Additionally or alternatively, in some embodiments the one or more criteria include a criterion that is satisfied when the electronic device and the storage device are communicatively coupled using a shared wireless network. Additionally or alternatively, in some embodiments the shared wireless network corresponds to a first communication channel, and wherein the first data is sent via a second communication channel, different from the first communication channel. Additionally or alternatively, in some embodiments the information about characteristics of the storage device includes hardware characteristics of the storage device. Additionally or alternatively, in some embodiments the information about characteristics of the storage device includes software characteristics of the storage device. Additionally or alternatively, in some embodiments the information about characteristics of the storage device includes one or more of a maximum number of devices that can concurrently communicate with the storage device, an indication of data types that are supported by the storage device, an amount data the storage device is capable of storing, and an identity of the storage device. Additionally or alternatively, in some embodiments the information about characteristics of the storage device is verified with an authority entity other than the electronic device and the storage device. Additionally or alternatively, in some embodiments the first data includes media. Additionally or alternatively, in some embodiments the first data includes spatial data associated with a physical environment of the electronic device and the storage device. Additionally or alternatively, in some embodiments the method further comprises, in response to receiving the information about characteristics of the storage device, sending a request to verify the information about characteristics of the storage device to a second electronic device, different from the storage device. The one or more or criteria can include a criterion that is satisfied when the information about the characteristics of the storage device is verified by the second electronic device. Additionally or alternatively, in some embodiments the method further comprises sending a request for information associated with the one or more first characteristics describing capability of the storage device to isolate the first data from other data stored on the storage device, and after sending the request for information, receiving the information associated with the one or more first characteristics based on the request for information. Additionally or alternatively, in some embodiments the method further comprises sending a request for the first data. The first data can be sent at a first time and the request can be sent at a second time, after the first time. The method can further comprise receiving an indication that the first data is not available. The indication can be based on a third time corresponding to time elapsed from the first time to the second time. Additionally or alternatively, in some embodiments the method further comprises sending a request for the first data, and receiving the first data from a second electronic device in communication with the storage device via the storage device.

Some embodiments are directed to an electronic device comprising memory and one or more processors coupled to the memory. The one or more processors can be configured to communicate with a storage device separate from the electronic device and the memory stores one or more instructions which when executed by the one or more processors cause the electronic device to perform a method of any of the methods described herein.

Some embodiments are directed to a non-transitory computer readable storage medium storing instructions, which when executed by an electronic device including one or more processors and configured to communicate with a storage device separate from the electronic device, causes the electronic device to perform a method of any the method described herein.

Some embodiments are directed to a system including one or more of the electronic devices and/or one or more of non-transitory computer readable storage mediums storing instructions described herein.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

1. A method comprising:
at an electronic device configured to communicate with a storage device separate from the electronic device:
detecting the storage device;
receiving, from the storage device, information about characteristics of the storage device, including one or more first characteristics describing capability of the storage device to isolate first data received from the electronic device from other data stored on the storage device;
in accordance with a determination that the information about characteristics of the storage device satisfies one or more criteria, sending the first data to the storage device for isolated storage on the storage device; and
in accordance with a determination that the information about characteristics of the storage device does not satisfy the one or more criteria, forgoing the sending of the first data to the storage device.

2. The method of claim 1, wherein the sending of the first data occurs during a first communication session, the method further comprising:
during a second communication, different from the first communication session:
sending a request for the first data to the storage device; and
receiving the first data from the storage device, wherein the receiving is based on the request for the first data.

3. The method of claim 1, wherein the sending of the first data occurs during a first communication session, the method further comprising:
during a second communication session, different from the first communication session:
in accordance with the determination that the information about characteristics of the storage device satisfies the one or more criteria, sending second data, different from the first data, to the storage device for isolated storage; and
in accordance with the determination that the information about characteristics of the storage device does not satisfy the one or more criteria, forgoing the sending of the second data to the storage device.

4. The method of claim 1, further comprising:
sending a request for second data, different from the first data, wherein the second data is stored at the storage device; and
receiving an indication that the second data is not accessible to the electronic device from the storage device.

5. The method of claim 1, wherein the information about characteristics of the storage device further comprises one or more second characteristics indicative of capability of the storage device to store the first data, and the one or more criteria include a first criterion that is satisfied when the one or more second characteristics indicate the storage device is capable of storing the first data.

6. The method of claim 1, wherein the information about characteristics of the storage device further comprises one or more second characteristics indicative of a level of trust associated with the storage device, and the one or more criteria include a first criterion that is satisfied when the one or more second characteristics include an indication of verification of an identity of the storage device.

7. The method of claim 1, wherein the electronic device is a portable device.

8. The method of claim 1, further comprising:
after detecting the storage device, establishing a secure communication channel with the storage device.

9. The method of claim 1, the method further comprising:
after detecting the storage device, sending information about characteristics of the electronic device.

10. The method of claim 1, wherein the one or more criteria include a criterion that is satisfied when the electronic device and the storage device are communicatively coupled using a shared wireless network.

11. The method of claim 1, wherein the information about characteristics of the storage device includes hardware characteristics of the storage device.

12. The method of claim 1, wherein the information about characteristics of the storage device includes software characteristics of the storage device.

13. The method of claim 1, wherein the information about characteristics of the storage device is verified with an authority entity other than the electronic device and the storage device.

14. The method of claim 1, wherein the first data includes spatial data associated with a physical environment of the electronic device and the storage device.

15. The method of claim 1, further comprising:
in response to receiving the information about characteristics of the storage device, sending a request to verify the information about characteristics of the storage device to a second electronic device, different from the storage device, wherein the one or more or criteria include a criterion that is satisfied when the information about the characteristics of the storage device is verified by the second electronic device.

16. The method of claim 1, further comprising:
sending a request for information associated with the one or more first characteristics describing capability of the storage device to isolate the first data from other data stored on the storage device; and
after sending the request for information, receiving the information associated with the one or more first characteristics based on the request for information.

17. The method of claim 1, further comprising:
sending a request for the first data, wherein the first data is sent at a first time and the request is sent at a second time, after the first time; and
receiving an indication that the first data is not available, wherein the indication is based on a third time corresponding to time elapsed from the first time to the second time.

18. The method of claim 1, further comprising:
sending a request for the first data; and
receiving the first data from a second electronic device in communication with the storage device via the storage device.

19. An electronic device comprising:
memory storing instructions; and
one or more processors coupled to the memory, the one or more processors configured to:
detect the storage device;
receive, from the storage device, information about characteristics of the storage device, including one or more first characteristics describing capability of the storage device to isolate first data received from the electronic device from other data stored on the storage device;
in accordance with a determination that the information about characteristics of the storage device satisfies one or more criteria, send the first data to the storage device for isolated storage on the storage device; and
in accordance with a determination that the information about characteristics of the storage device does not satisfy the one or more criteria, forgo the sending of the first data to the storage device.

20. A non-transitory computer readable storage medium storing instructions that, when executed at an electronic device including memory storing instructions and including one or more processors coupled to the memory, causes the electronic device to:
detect the storage device;
receive, from the storage device, information about characteristics of the storage device, including one or more first characteristics describing capability of the storage device to isolate first data received from the electronic device from other data stored on the storage device;
in accordance with a determination that the information about characteristics of the storage device satisfies one or more criteria, send the first data to the storage device for isolated storage on the storage device; and
in accordance with a determination that the information about characteristics of the storage device does not satisfy the one or more criteria, forgo the sending of the first data to the storage device.
